(19) United States
(12) Patent Application Publication
(10) Pub. No.: US 2008/0270327 A1
(43) Pub. Date: Oct. 30, 2008

(54) Commissioning System

(75) Inventor: Karl Freudelsperger, Hart bei Graz (AT)

Correspondence Address: WORKMAN NYDEGGER, 60 EAST SOUTH TEMPLE, 1000 EAGLE GATE TOWER, SALT LAKE CITY, UT, 84111, US

(73) Assignee: KNAPP LOGISTIK AUTOMATION GMBH, Hart bei Graz (AT)

(21) Appl. No.: 11/575,213

(22) PCT Filed: Sep. 14, 2005
(86) PCT No.: PCT/AT05/00370

§ 371 Date: Feb. 12, 2008

(30) Foreign Application Priority Data
Sep. 14, 2004 (AT) A 1540/2004

(51) Int. Cl. G06Q 90/00

(52) U.S. Cl. 705/500

(57) ABSTRACT

A process for commissioning customer orders for placing products ready in a desired number of pieces comprises assigning each customer order to at least one order storage container (6), fetching the products as specified in the customer order in the required number of pieces from a main store (2) and putting the products fetched into the at least one order storage container (6) assigned to the customer order and—for each customer order—transferring the products temporarily stored in the at least one order storage container (6) assigned to the customer order to a collective conveyor (3) at a time fixed for the customer order.

The present invention relates to a process for commissioning customer orders. The invention in particular relates to a commissioning process for a semi-automatic commissioning system.

With commissioning systems there frequently is the problem of an irregular utilization of their capacity. While seen from a time perspective the average utilization of the commissioning system's capacity may well be moderate, there may at the same time be utilization peaks when a high number of products have to be commissioned as quickly as possible. A typical example for this are warehouses from where delivery tours with products ordered depart at certain times. For the customer it is important to be able to place commissions, i.e. customer orders, for a certain delivery round at the warehouse for as long as possible. According to the prior art, a customer's orders are dealt with only after the deadline for orders, all at the same time, even if the customer has placed his orders as several partial commissions. As the warehouse operator will naturally also be interested in offering order periods that are as long as possible so as to receive as many customer orders as possible, this known way of dealing with orders results in the occurrence of utilization peaks in the short period between the deadline for orders and the departure of the delivery tour, peaks which may often not be dealt with in time, leading to delivery delays or to the incomplete processing of customers' orders, or it becomes necessary to provide for safety time reserves between the deadline for orders and delivery, which again shorten the order period.

With the prior art commissioning systems and processes for the operation thereof there are hardly any possibilities for optimization in case of manual commissioning of the goods, as a certain person at the warehouse always only handles one order at a time.

Therefore the basic aim of the present invention is to provide a process for commissioning customer orders which makes it possible to avoid utilization peaks in a commissioning system to a large extent, and in any case to significantly reduce them and, on the whole, to achieve a more uniform utilization of the commissioning system and a higher throughput speed.

This aim is achieved by a process for commissioning customer orders according to claim 1. Advantageous embodiments of the invention are outlined in the sub-claims.

The process according to the invention for commissioning customer orders for placing products ready in a desired number of pieces comprises the following steps: assigning each customer order to at least one order storage container, fetching the required number of pieces of the products as named in the customer order from a main store and putting the products fetched into the at least one order storage container assigned to the customer order and—for each customer order—transferring the products temporarily stored in the at least one order storage container assigned to the customer order to a collective conveyor at a time fixed for the customer order.

By means of the temporary storage of the products belonging to one customer order in order storage containers the process according to the invention enables a far-reaching temporal extension of dealing with the customer orders and the dissociation between fetching the products from the main store and passing these products on to the collective conveyor.

The temporal extension of dealing with the customer orders may further be supported by admitting partial orders to be placed by customers, an embodiment of the invention providing for several partial orders belonging together to be combined to one customer order, to which at least one order storage container is assigned, the fact of the partial orders belonging together being establishable on the basis of customer order identification features, like customer name, customer address, customer number, customer order number, etc. Thus the warehouse operator will be able to achieve a more uniform utilization of his commissioning system by offering the customer an incentive (e.g. discounts) for not placing a joint order as late as possible, but placing partial orders as early as possible instead.

In order to reduce the sorting work necessary in a dispatch section downstream of the commissioning system, the products of each customer order, which are temporarily stored in the at least one order storage container, may be transferred to the collective conveyor in such a sequence as to minimize the sorting work in the subsequent dispatch section. The goods of the customer orders may for instance be passed on to the collective conveyor in such a way that they are loaded onto delivery trucks in a sequence of “first in, last-out,” this sequence being adapted to the truck's delivery tour.

The products will in most cases be manually fetched from the main store by commissioners. In order to employ the commissioners as efficiently as possible and in order to make their working conditions easier, one embodiment of the invention provides for the drawing up of fetching orders for commissioners for fetching the products from the main store, one fetching order comprising the products to be fetched as well as their number of pieces, the products of several customer orders, which will be fetched from the main store together and subsequently be put into the assigned order storage containers according to the customer orders, being combinable. The combined fetching of products for several customer orders is called “product batch formation”.

It is to be mentioned that customer orders or partial orders arriving at the warehouse and commissioning store, respectively, may be split up into several commissioning orders which are dealt with in different parts of the warehouse or by different commissioners or by one commissioner at different times, each commissioning order prescribing commissioning of at least one part of the products given in the customer order. One fetching order may in turn combine commissioning orders for different customer orders.

The commissioners' work may be made efficient by arranging the products listed in the fetching order in such a sequence as to minimize the distance a commissioner has to cover on his way through the main store. In this context it may also be taken into consideration that the commissioners should not be in each other's way in the mostly narrow passages of the main store. In order to achieve this, the commissioners may be led through the main store according to the round robin system.

In case of urgent orders which have to be dealt with as quickly as possible it is generally not suitable to optimize the distance covered. In such a case the invention instead provides for the fetching order to comprise those products that are necessary for completing a customer order so that it may be passed on to the collective conveyor as quickly as possible.

For the commissioners to be able to work without disturbing each other and in order to scale the process up or down depending on the work load by increasing or reducing the number of commissioners employed, a further embodiment of the invention provides for several order storage containers to be combined to one order storage shelf and for several order storage shelves to be arranged along the collective conveyor, each order storage shelf preferably always being assigned to one commissioner. The order storage shelves may be manned by commissioners according to work load.

In order to avoid the necessity of an undesirably long collective conveyor in case of large-volume customer orders, one variant of the invention provides for the distribution of several order storage containers assigned to one customer order over different order storage shelves. When passing the products stored in the order storage containers for one customer order on to the collective conveyor the products of this customer order are distributed over several positions on the collective conveyor.

In case it turns out that an order storage container is not large enough for accommodating all products destined therefore while the products are being put into place, it is furthermore provided that the commissioner may request the allocation of additional order storage containers to a customer order.

The major aspects of the commissioning system according to the invention are:
By assigning customer orders to customer order-related order storage containers it is possible to form “product batches”, i.e. the commissioner may fetch the products for several customer orders from a main store at the same time and subsequently distribute them into the order storage containers assigned to the respective customer orders, the products temporarily being stored there until they are passed onto a collective conveyor. This enables the commissioning personnel to be guided in an optimum way while they are fetching the products.
A major reduction of working steps as compared to prior art commissioning systems is achieved, in particular by way of shorter and fewer fetching journeys (commissioning journeys).
Manual processes are dissociated from automatic processes. The “delivery part”, which may sometimes be critical in its time aspect, i.e. the passing of the products specified in the customer order onto the main conveyor and the shipment thereof, becomes much less critical, as it almost exclusively consists of automatic processes and as the compilation of products for the respective customer orders had already been completed before within a relatively long period of time.
All processes involved may be treated within deterministic time.
The commissioning system according to the invention is a scalable system. It enables the easy addition and reduction of resources.
Customer orders are available for delivery within a definable time. There are hardly any interactions of orders.
The system ideally supports the possible sorting of transport containers at the warehouse.

The commissioning system according to the invention preferably takes the form of a semi-automatic two-stage automated system.

The first stage is a manual commissioning stage and comprises filling the order storage containers. For this the commissioner receives fetching orders from a master computer by way of a (radio) terminal, these orders giving the number and kind of products to be fetched from the main store, the products for several customer orders being combined (batched). The commissioner therefore commissions (fetches) from the main store in a product-centered way and distributes the products fetched over the order storage containers in a customer order-centered way. In this the commissioner is conveniently guided by means of a hand-held RF-terminal.

The second commissioning stage is the automatic commissioning of the products arranged according to customer orders from the order storage containers onto a collective conveyor, as e.g. a central conveyor belt. Commissioning onto the collective conveyor is carried out in a sequence optimized for the subsequent shipment of customer orders. In this way the temporary storage of products in the order storage containers is used for simplifying the sorting for shipment. In this it is of particular advantage that because of the formation of order batches it will be possible to automatically commission onto the collective conveyor in a (freely) defined sequence of customer orders, this sequence being chosen so that the sorting of transport containers each containing the products for one customer, may be reduced to a minimum (optimum zero) for shipment in the dispatch section.

The commissioning process and system according to the invention will in the following be explained by way of an embodiment thereof, explaining its mechanical structure, hardware and controlling means as well as the commissioning procedure. In the drawings:

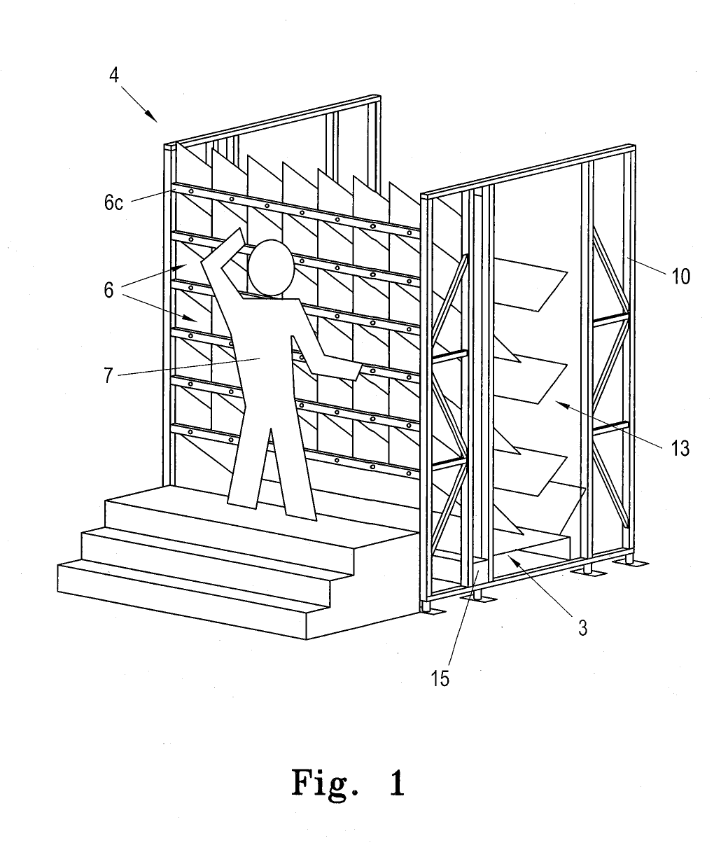

FIG. 1 shows a perspective view of an order storage shelf having a plurality of order storage containers and of a collective conveyor as elements of the commissioning system according to the invention;

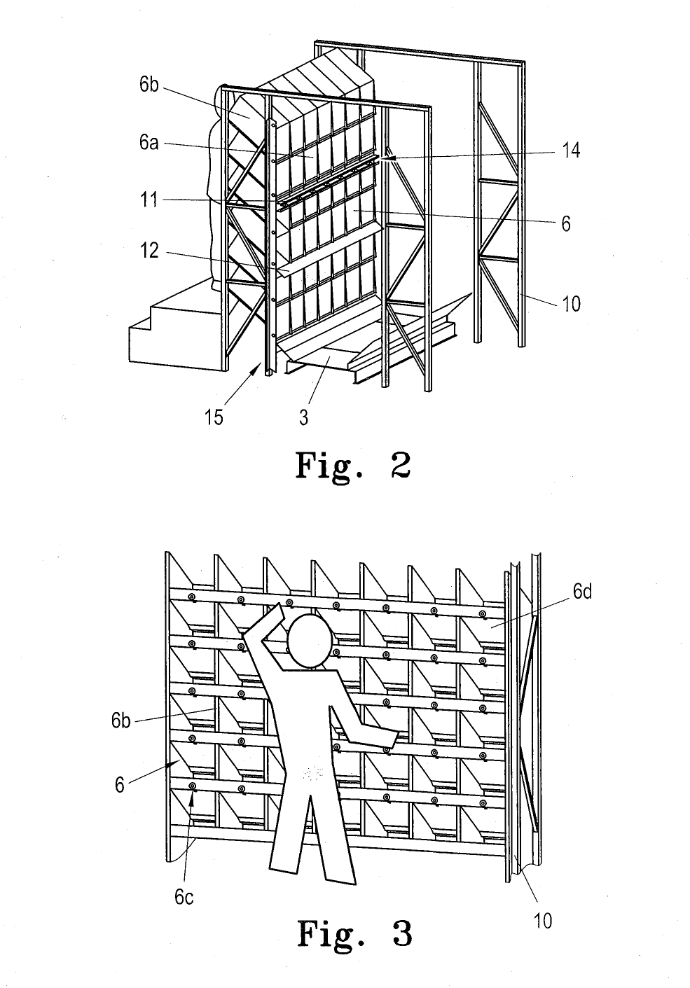

FIG. 2 shows the order storage shelf of FIG. 1, as viewed from the side of the collective conveyor;

FIG. 3 is a detailed view of the order storage containers;

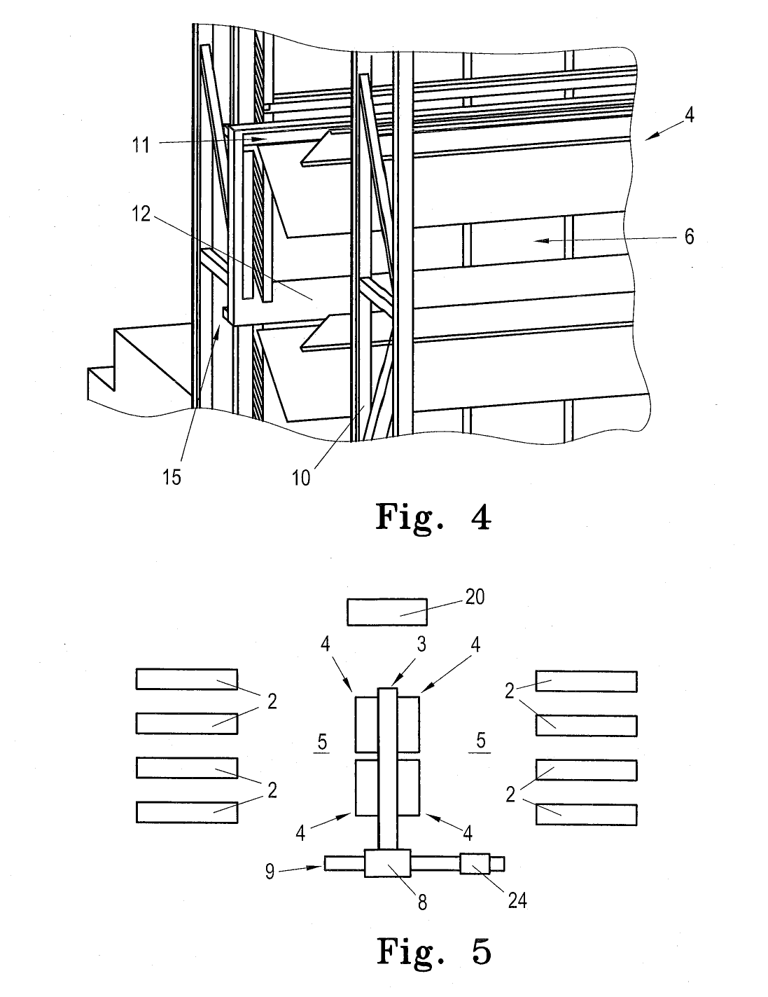

FIG. 4 is a detailed view of the opening and closing mechanism of the order storage containers;

FIG. 5 is a schematic overall view of the commissioning system according to the invention;

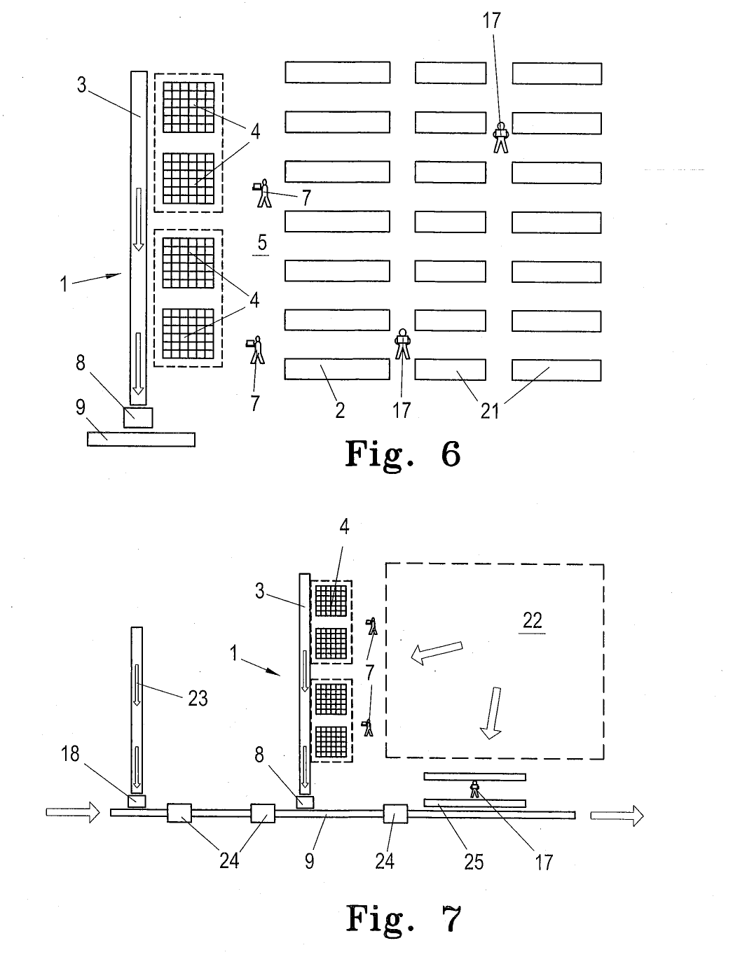

FIG. 6 shows a schematic setup of a commissioning system according to the invention;

FIG. 7 shows a schematic setup of a commissioning store having a commissioning system according to the invention;

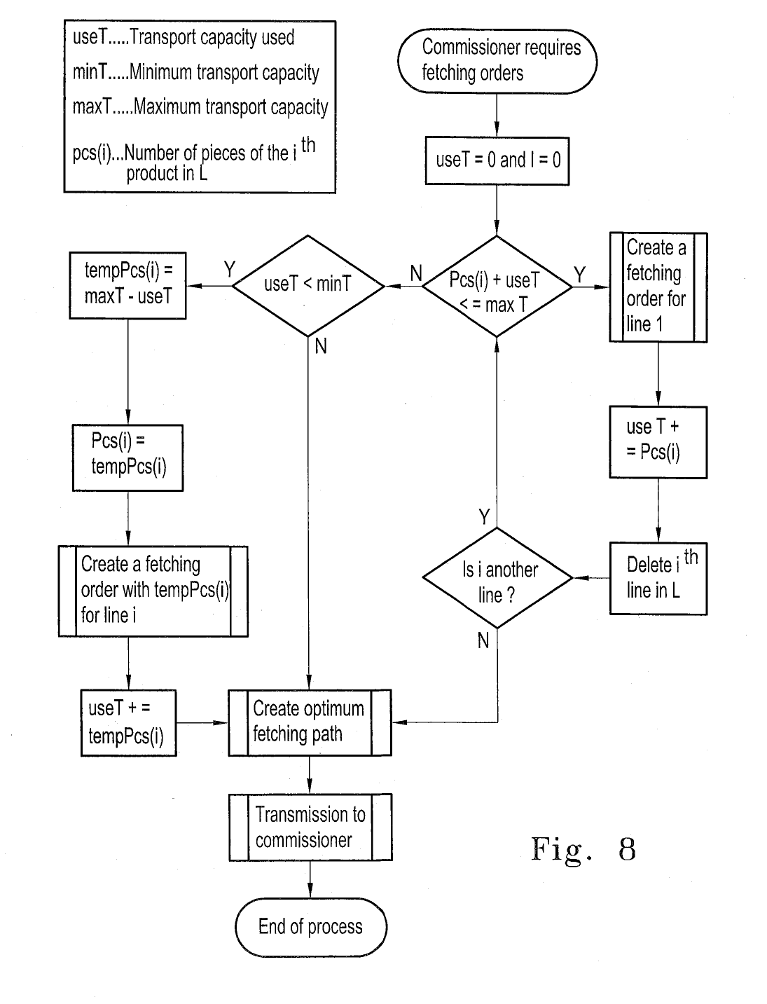

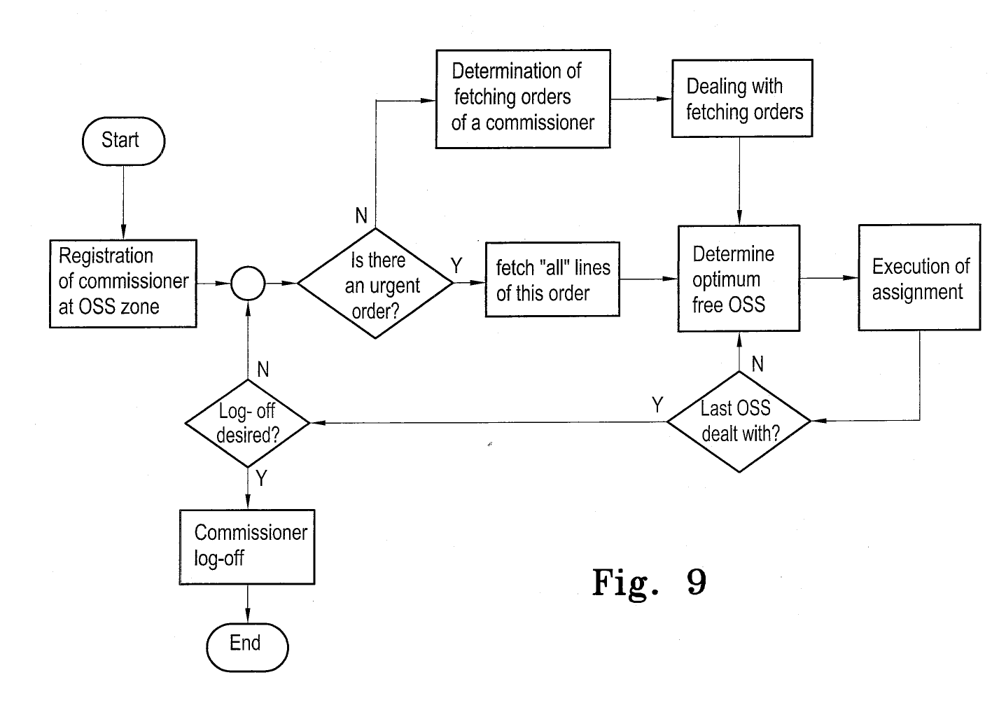

FIG. 8 shows a flow chart for fetching orders for one commissioner;

FIG. 9 shows a flow chart of a commissioning process according to the invention.

First referring to FIG. 5, it schematically explains a commissioning system 1 according to the invention for carrying out the process according to the invention for commissioning customer orders. The commissioning system 1 comprises a plurality of main stores 2 taking the form of static storage shelves arranged in two groups one opposite the other. In the drawing each group comprises four main stores 2, but it is understood that the invention is not limited thereto. The main stores 2 hold the products that may be ordered by the customers of the commissioning store. Between the two groups of main stores 2 there is a collective conveyor 3 taking the form of a central conveyor belt. To the left and to the right the collective conveyor 3 has two order storage shelves 4 each, and they in turn have a plurality of order storage containers 6, as shown in FIG. 1. The space between the order storage shelves 4 and the main stores 2 is the commissioning region 5, where the commissioners 7 work unless they are moving around in the passages between the main stores 2 in order to fetch products from the main stores. Products commissioned onto the collective conveyor 3 are, in containers or loosely, transported to a discharge station 8, where they are discharged into transport containers 24 moving to a dispatch section not shown along a container path 9. The transport containers 24 may also hold products required for the customer order from other parts of the commissioning store if the customer order was divided into several commissioning orders. The commissioning system 1 is controlled via one or several computers 20, which may also be arranged hierarchically (master computer—control computer etc.).

FIG. 1 shows the mechanical structure of an order storage shelf 4 arranged at the collective conveyor as viewed in perspective from the nearest main store. FIG. 2 shows the order storage shelf 4 as seen from the side of the collective conveyor. FIGS. 1 and 2 illustrate the arrangement of mechanical components of the order storage shelf 4. The drawing shows a frame 10 and a plurality of order storage containers 6 arranged in a matrix of seven columns and six rows and taking the form of cups the bottoms 6d of which are inclined towards the collective conveyor 3. That side wall 6a of each order storage container 6 which faces towards the collective conveyor 3 may be engaged with vertically moveable crossbeams 11 by means of actuators taking the form of lifting magnets 14 and may thus be moved vertically upwards and downwards, so that the order storage container 6 may be opened and closed. Reference numeral 15 designates the drive and guiding system for the vertically moveable crossbeams 11. When side wall 6a is opened the products temporarily stored in order storage container 6 glide out and fall onto the collective conveyor 3, their speed being reduced by cascades 12, 13 of obliquely arranged metal sheets, and are thus transported to discharge station 8. It is to be mentioned that the side walls 6a may for instance also be hinged to the order storage containers 6 and be opened and closed by means of a motor, the movements of the side walls 6a being timed by a computer so that the products of a respective order fall onto the collective conveyor 3 at an exactly defined moment. Every order storage container 6 furthermore comprises a housing formed by the bottom 6d and lateral partition walls 6b as well as an acknowledge light and switch module 6c. In the customer-order centered assignment of products the commissioner is guided to the correct order storage container 6 by means of the acknowledge light. By way of the acknowledge switch the commissioner confirms manually for each order line of his fetching order that he has manually placed a product fetched from the main store 2 according to his fetching order in the order storage container 6 in a customer-order centered way, i.e. in the number required for a certain customer order.

The arrangement of order storage containers 6 within frame 10 next to each other and one row on top of the other may best be seen in FIG. 3. The arrangement of moveable side walls 6a on partition walls 6b can also be seen.

As shown in FIG. 4 the system of crossbeams having integrated actuators (lifting magnets 14) comprises a crossbeam 11 and a cascade sheet 12 beneath it which also serves the function of a crossbeam. The distance separating the two crossbeams is defined depending on the division of levels of order storage containers 6 in order storage shelf 4.

For commissioning the customer orders, in most cases several customer orders (or the commissioning orders made up of them) will be combined to order batches assigned to one commissioning region 5 each. Several order storage shelves 4 may be assigned to one commissioning region 5. Several commissioners 7 may work in one commissioning region 5, only one commissioner 7 best being assigned to every order storage shelf 4 in the respective commissioning region 5 at any time, so that the commissioners will not be in each other's way during their work. As a means of stocking the products in the commissioning store, static shelves constituting main stores 2 are arranged in parallel to the order storage shelves 4. FIG. 5 shows a possible arrangement in case the order storage shelves 4 are arranged on both sides of the collective conveyor 3.

By assigning the commissioners 7 to a commissioning region 5 an optimization of the products to be fetched from the main stores 2 for dealing with the order batches is possible beyond the order storage shelves 4. This results in the optimization of commissioning journeys to the respective order storage shelf 4 depending on the product storage sites in the main stores 2.

In the following an embodiment of a commissioning process according to the invention will be explained:

For commissioning fetching orders including product data are transmitted to the commissioner 7 via radio to his hand-held terminal and shown line-by-line on the display of the hand-held terminal. As an additional information the storage site of the stock in the main store 2 and the required number of pieces for one collection round in the main store may be displayed, the products for several customer orders (order batches) being combined for this collection round. In order for the transmission of the fetching order to the hand-held terminal to take place the commissioner 7 must be registered in the commissioning region 5 assigned to him. The collection of products in the main store 2 is radio-supported. Following the gathering (pre-commissioning) of a defined number of different products, the transportation of these products advantageously being carried out by means of auxiliary devices (e.g. push cars with screen divisioning), the commissioner 7 registers at a free order storage shelf 4 in the commissioning region 5 assigned to him. Next a first one of the products fetched according to the fetching order is scanned by means of finger scan with the hand-held terminal for the purpose of product identification.

After successful product recognition the display of his hand-held terminal shows the commissioner 7 the number of pieces of the product required to be arranged in an order storage container 6, and the order storage container 6 to be filled with the product is indicated by way of the signal light on the acknowledgement switch 6c of the order storage shelf 4. When the order storage container 6 has been filled by hand, the commissioner actuates the acknowledgement switch 6c for manual confirmation. If the same product is required for a further customer order in this order storage shelf 4, the commissioner is instructed to fill the next order storage container 6 by the display of the hand-held terminal showing the now required number of pieces of the product. If the current product is not required for an additional customer order in this order storage shelf 4, the commissioner is informed to this effect via the display. The commissioner also is shown his possible assignment to a further order storage shelf 4 within the commissioning region 5. In case this order storage shelf 4 is free, the desired number of pieces of the product may be supplied to one or several designated order storage containers 6 by way of registration at the new order storage shelf 4.

It may be of advantage to finish dealing with all products fetched from the main store 2 in a customer order-centered way (i.e. by filling the order storage containers 6 assigned to the customer orders) in the respective order storage shelf 4 before the commissioner turns to a different order storage shelf 4. In this case, as soon as all products required for the current order storage shelf 4 have been commissioned, the commissioner 7 receives an indication to this effect on the display of his hand-held terminal, whereupon he may address the next free order storage shelf 4.

For recognition and the resulting possibility to assign a new product to an order storage container 6 this next order storage shelf 4 again has to be identified via finger scan. Then proceedings may be as described above.

Throughout the process, including error management, the commissioner is guided via the display of his hand-held terminal.

FIG. 6 shows a schematic setup of a commissioning system 1 according to the invention. FIG. 7 shows a schematic setup of a commissioning store comprising a commissioning system 1. The commissioning system 1 comprises four order storage shelves 4 arranged to one side of a collective conveyor 3 taking the form of a central belt, conveying the commissioned products customer order by customer order to a discharge station 8 where they are passed on to transport containers 24 moving along a container conveying path 9. The commissioning store comprises a product section 22 (see FIG. 7), which is divided into main storage shelves 2 adjacent to the order storage shelves 4 and additional static shelves 21, a commissioning region 5, in which commissioners 7 are registered, being defined between the main storage shelves 2 and the order storage shelves 4. In the main storage shelves 2 there are B products, i.e. products demanded with average frequency. In the static shelves 21 there are C products or slowly turning products which are demanded infrequently. These are fetched by other commissioners 17 and put into the transport containers 24 at a discharge station 25 by hand. Upstream of commissioning system 1 there is an automatic commissioning machine 23 for quickly turning products, putting the products into the transport containers 24 at a discharge station 18. For instance every order storage shelf 4 consists of seven rows and ten columns of order storage containers. For every order storage shelf 4 this offers temporary storage options for 70 potential customer orders. The order storage shelves 4 are combined into zones comprising two order storage shelves each. For ergonomic reasons the assignment of customer orders to order storage containers in the center of the order storage shelves is preferred.

Basically three core processes become apparent for dealing with the customer orders and the commissioning orders formed of the customer orders, respectively. These are the preparative processing and the commissioning of customer orders or commissioning orders as well at the dispatch of products commissioned according to customer orders.

Preparative processing comprises all activities concerned with the considerate assignment of orders as well as the intelligent preparation of product data.

The purpose of customer order assignment is to reserve order storage containers for customer orders. As it doesn't make sense to start dealing with customer orders right away, the assignment is divided into a startup phase and a procedural phase.

In definable time intervals a master computer examines whether there is a defined number of customer orders the order period of which is shorter than the current simulation time. If this is the case, it assigns these customer orders to the individual order storage containers in one or several order storage shelves according to the initial scheme.

During the procedural phase every customer order having an order period that is shorter than the current simulation time is assigned to a free order storage container. The assignment scheme is utilized for this.

### Rule:

The following procedure is used as an initial scheme. First the number N of registered commissioners is determined. In case N is larger than the number of order storage shelves within the zone, N has to be brought to the number of order storage shelves. A number of N optional order storage shelves from this zone are chosen. In a round robin process, (i.e. in sequence) the customer orders ripe for assignment (order period shorter than current simulation time) are assigned to individual order storage containers, order storage containers in the center of the order storage shelves being occupied first for ergonomic reasons.
The assignment scheme distributes a customer order or commissioning order ripe for assignment according to the round robin principle, an even occupation of order storage shelves being aimed at. Here, too, central order storage shelf positions are preferred in order to keep the distances a commissioner has to cover short.
It may be the case that the volume of the order storage container is too small for holding all the products of a customer order, or that the products are too heavy. In this case at least one follow-up order storage container has to be reserved for this order. This follow-up order container has to be reserved in a different order storage shelf so as to avoid an unnecessarily great belt length of the collective conveyor.
If no more order storage containers are free, an already filled order storage container has to be made available by putting a transport container into operation and releasing the contents of the order storage container onto the collective conveyor. If this is not possible, the customer order has to be deferred.
Division of orders: as this setup comprises an arrangement of order storage shelves and main stores on both sides with respect to the collective conveyor, it is necessary to examine every customer order with respect to its possibly necessary division. This becomes necessary if products from the main stores on both sides of the collective conveyor have to be commissioned for the customer order.

The initial and the assignment scheme are exemplary approaches for the commissioning process according to the invention without being exclusive.

### Preparative Processing of Customer Orders

For every zone a list of product orders is maintained. This list shows which and how many products in this zones still have to be converted into fetching orders.

Whenever a new customer order is assigned to an order storage container, the products required for this order are added to this list. This is done according to the following scheme:
If the product is already included in the list, the product numerator is increased by the required number.
If the product is not yet included in the list, it is added to the list and initialized with the required number of pieces.

### Sorting of Product Orders

The list of product orders is maintained in a sorted state. The sorting utilized depends on the number of pieces required:

If it is possible to deduce the total frequency from the number of pieces given in the list, those products with a lower piece number should be preferred here. On the one hand, this has the advantage that the probability of this product appearing in the next customer order again is lower than in case of a product with a higher frequency. On the other hand, the moment of fetching a product required “more frequently” is delayed, giving new customer orders that may require this product a chance to place “their pieces” as well.

### Determination of Fetching Sequence

A fetching order is an invitation to a commissioner to fetch a certain number of pieces of a product for a zone from the main store. Every commissioner has a minimum and a maximum “transportation capacity”, depending on the product volume, its weight and the number of different products as well as on the nature of the transport system he has at his disposal.

Fetching orders are drawn up according to the scheme of FIG. 8, this process being passed only if the commissioner is ready to fetch products.

### Commissioning

FIG. 9 shows a commissioning scheme.

### Commissioner Registration

The commissioner has to register at a commissioning zone when taking up his work. This is done via his hand-held RF-terminal. With this registration it is possible to transmit fetching and assignment orders to the commissioner. From the point of view of simulation, the commissioner's individual minimum and maximum “transport capacity” in pieces of arbitrary products is determined with this registration as well.

### Fetching of Goods

The commissioner is assigned fetching orders for his zone. Each fetching order consists of the products and the required number of pieces thereof. In case the commissioner still has available capacities, he may receive further fetching orders. If he has been assigned several fetching orders, a time-optimized route across the main store to the stored products has to be chosen.

### Rule

It is attempted to fully exploit the commissioner's maximum “transport capacity”. According to this rule, fetching orders may be divided up. This does, however, only make sense up to a certain point (compare going to this product storage place vs. commissioning products). A fetching order for the next product is produced in any case if the commissioner's current “product enumerator” is below his minimum “transport capacity”.

### Assignment of Products

When the commissioner has fetched all products from the main store according to his fetching order, he may start commissioning, i.e. placing the products in the order storage containers. For this purpose he goes from his last fetching position to the nearest free order storage shelf, displayed on the hand-held RF-terminal, and registers there via radio. The master system displays the first line (product and number) on the hand-held RF-terminal and activates the control lamp on the respective order storage container. The commissioner takes the required number of products and puts the products into the order storage container. For confirmation he presses the acknowledge switch. This procedure is referred to as assignment order and is carried out until all products the commissioner has with him according to his fetching orders for this order storage shelf have been commissioned.

The hand-held RF-terminal shows the commissioner that the assignment orders for this shelf have been dealt with by either displaying a new fetching order, in case this has been the last assignment order, or by displaying the next “uncommissioned” order storage shelf in which further assignment orders are to be carried out.

### Commissioner Log-Off

Following completion of the last assignment order the commissioner has the possibility to log off from the zone. In this case the fetching orders that may already have been displayed to him are assigned to a different commissioner by the master system.

### Urgent Orders

A customer order will for instance become an urgent order if the departure time of a delivery vehicle minus a predetermined period of time already is behind the current time. The predetermined period of time primarily consists of the transfer time of products of the customer order from the order storage shelf to a dispatch section plus various manipulation times as well as safety time reserves.

The aim to be achieved has to be to finish this customer order as quickly as possible. For this purpose the master computer transmits fetching orders onto the hand-held RF-terminal of the next free registered commissioner. These fetching orders are however not batched (i.e. collected) product orders focusing on fetching several products for many customer orders (principle of optimization of distances) as in normal operation, but focusing on serving few customer orders (one customer order) with many (all) products) in order to complete the customer orders (principle of completion).

### Shipment of Customer Orders

### Collective Conveyor Reservation

Collective conveyor reservation, i.e. the reservation of a portion of suitable length on a collective conveyor for receiving the products to be discharged from the order storage containers customer order by customer order, is important in order to ensure that the products conveyed on the reserved portion of the collective conveyor do indeed belong to one customer order, and is also important for the speed of the system. The length of the portion of the collective conveyor to be reserved is primarily determined by the height of fall of the products from the order storage container (through the cascades) onto the collective conveyor and by the safety margin on the collective conveyor.

The following is a glossary of the specific terms used in the specification.

### Urgent Order

Is a customer order in which time plays a critical role.

### Fetching Order

A fetching order is a request to a commissioner to fetch a specified number of pieces of a product from a main store for order storage shelves of one zone.

### Commissioning Order

A commissioning order is an order derived from a customer order by the superordinate system and consisting of order lines (product, number of pieces).

### Customer Order

A customer order comprises an order list of products and their numbers by a customer to a commissioning store for the delivery of these products within a desired period of time.

### Product Order

The master computer turns customer orders that have been filed into product orders. These are pairs of a product and the number of pieces required thereof, which have however not been assigned to a commissioner yet.

### Zone

A zone is a combination of order storage shelves. A commissioner will be responsible exclusively for one zone. Commissioning across zones by one commissioner is undesirable.

### Assignment Order

An assignment order comprises a product, the number of pieces required for a customer order as well as an order storage container in an order storage shelf. This information serves the commissioner to effectively commission an order line.

1-9. (canceled)

10. A process for commissioning customer orders for placing products ready in a desired number of pieces, comprising:
assigning each customer order to at least one order storage container;
fetching the products as specified in the customer order in the required number of pieces from a main store and putting the products fetched into the at least one order storage container assigned to the customer order; and
for each customer order, transferring the products temporarily stored in the at least one order storage container assigned to the customer order to a collective conveyor at a time fixed for the customer order, wherein:
fetching orders for commissioners are drawn up for fetching the products from the main store, one fetching order comprising the products to be fetched and their number of pieces, it being possible to combine the products of several customer orders, which are fetched from the main store together and are subsequently put into the assigned order storage containers in accordance with the customer orders.

11. The process according to claim 10, wherein several partial customer orders belonging together are combined to one customer order to which at least one order storage container is assigned, the fact of the partial orders belonging together being establishable on the basis of customer order identification features.

12. The process according to claim 11, wherein the order identification features include at least one of a customer name, a customer address, a customer number, and a customer order number.

13. The process according to claim 11, wherein the products of each customer order temporarily stored in the at least one order storage container are transferred to the collective conveyor in such a sequence of customer orders as to minimize the sorting work in a subsequent dispatch section.

14. The process according to claim 11, wherein several order storage containers are combined to one order storage shelf and that several order storage shelves are arranged along the collective conveyor.

15. The process according to claim 14, wherein each order storage shelf is assigned to one commissioner at a time.

16. The process according to claim 14, wherein several order storage containers assigned to one customer order are distributed over several order storage shelves.

17. The process according to claim 16, wherein the commissioner may request that additional order storage containers be assigned to a customer order.

18. The process according to claim 14, wherein the commissioner may request that additional order storage containers be assigned to a customer order.

19. The process according to claim 10, wherein the products of each customer order temporarily stored in the at least one order storage container are transferred to the collective conveyor in such a sequence of customer orders as to minimize the sorting work in a subsequent dispatch section.

20. The process according to claim 10, wherein the products listed in the fetching order are arranged in such a sequence as to minimize the distance covered by the commissioner on his way through the main store.

21. The process according to claim 10, wherein the fetching order comprises those products required for completing a customer order.

22. The process according claim 10, wherein several order storage containers are combined to one order storage shelf and that several order storage shelves are arranged along the collective conveyor.

23. The process according to claim 22, wherein each order storage shelf is assigned to one commissioner at a time.

24. The process according to claim 22, wherein several order storage containers assigned to one customer order are distributed over several order storage shelves.

25. The process according to claim 24, wherein the commissioner may request that additional order storage containers be assigned to a customer order.

26. The process according to claim 22, wherein the commissioner may request that additional order storage containers be assigned to a customer order.
